(19) United States
(12) Patent Application Publication
(10) Pub. No.: US 2016/0318138 A1
(43) Pub. Date: Nov. 3, 2016

(54) HEAT EXCHANGE HEADER

(71) Applicant: Southwest Research Institute, San Antonio, TX (US)

(72) Inventor: Jason C. WILKES, Fair Oaks Ranch, TX (US)

(21) Appl. No.: 14/700,705

(22) Filed: Apr. 30, 2015

(51) Int. Cl. B23P 15/26; F28F 9/02

(52) U.S. Cl. CPC B23P 15/26; F28F 9/02

(57) ABSTRACT

The present disclosure relates to methods of manufacture of a header design for a heat exchanger and the header itself comprising a plurality of heat exchange tubes configured to receive coolant and a header containing a profiled opening to receive the plurality of heat exchange tubes wherein the header is configured to be sealingly engaged to a pipe for delivery of coolant between the pipe and the plurality of heat exchange tubes.

### FIELD OF INVENTION

The present disclosure relates to heat exchange systems, and in particular, to a design for improved manufacturability of a header particularly suitable for a supercritical heat exchanger.

### BACKGROUND

Heat exchangers, for example of the shell-and-tube variety, generally employ a header (e.g., a type of fitting) to couple the relatively large number of heat exchange tubes to a larger pipe that supplies (or removes) heat from the system. The header is typically fabricated by drilling holes through a metal plate and running the heat exchange tubes through these holes to provide an outlet to the pipe.

Supercritical CO₂ heat exchange systems are becoming increasingly popular as an emerging technology that provides improved power cycle efficiency. Such systems, however, typically operate at higher temperatures and pressures than more conventional heat exchange systems, thus the heat exchangers are often designed with very small tubes to reduce stresses. In addition, the amount of recuperated heat in the cycles is generally very high. This in turn often requires a relatively substantial increase in the number of heat exchange tubes along with a decrease in the size (e.g., diameter) of those tubes. This presents a manufacturing challenge as the drilling of holes through the header can be time consuming and expensive. What is needed, therefore, are improved systems and methods for heat exchangers and the manufacture thereof.

### SUMMARY

The present disclosure describes methods and systems for heat exchangers and the fabrication thereof. The use of a single profiled opening in the header of a shell-and-tube heat exchanger allows for a relatively less costly and more efficient manufacturing process compared to existing systems that require separately drilled bore holes for each heat exchange tube.

One example of the present disclosure therefore relates to a method for fabrication of a header for a heat exchanger, the method comprising arranging a plurality of heat exchange tubes to be configured as a bundle, forming a profiled opening in a header, fitting the bundle of tubes into the profiled opening of the header and fixing the heat exchange tubes to each other within the bundle and fixing the bundle to the header.

In another example the present disclosure similarly relates to a method for fabrication of a header for a heat exchanger, the method comprising arranging a plurality of heat exchange tubes to be configured as a bundle, forming a profiled opening in a header, inserting the bundle of tubes into the profiled opening and fixing the heat exchange tubes to each other within the bundle and to the header at the same time.

Moreover, the present disclosure relates to a header for a heat exchanger comprising a plurality of heat exchange tubes configured to receive coolant and a header containing a profiled opening to receive the plurality of heat exchange tubes wherein the header is configured to be sealingly engaged to a pipe for delivery of coolant between the pipe and the plurality of heat exchange tubes.

### BRIEF DESCRIPTION OF DRAWINGS

The above-mentioned and other features of this disclosure, and the manner of attaining them, will become more apparent and better understood by reference to the following description of embodiments described herein taken in conjunction with the accompanying drawings, wherein:

FIG. 1 illustrates a top level system diagram of a heat exchanger system;

FIG. 2 illustrates a header configuration for a heat exchanger consistent with one exemplary embodiment of the present disclosure;

FIG. 3 illustrates cross sections of header configurations in accordance with exemplary embodiments of the present disclosure;

FIG. 3B illustrates a cross section of a header showing the identified hexagonal tubes in direct contact;

FIG. 4 illustrates a heat exchanger in accordance with an exemplary embodiment of the present disclosure;

FIG. 5 illustrates a heat exchanger in accordance with another exemplary embodiment of the present disclosure;

FIG. 6 illustrates a flowchart of operations of another exemplary embodiment consistent with the present disclosure; and

### DETAILED DESCRIPTION OF PREFERRED EMBODIMENTS

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

The present disclosure relates generally to heat exchangers and more particularly to a design for improved manufacturability of a supercritical heat exchanger. The header of a shell-and-tube heat exchanger may be configured with a single profiled opening that allows for a less costly and more efficient manufacturing process compared to existing systems that require separately drilled bore holes for each heat exchange tube.

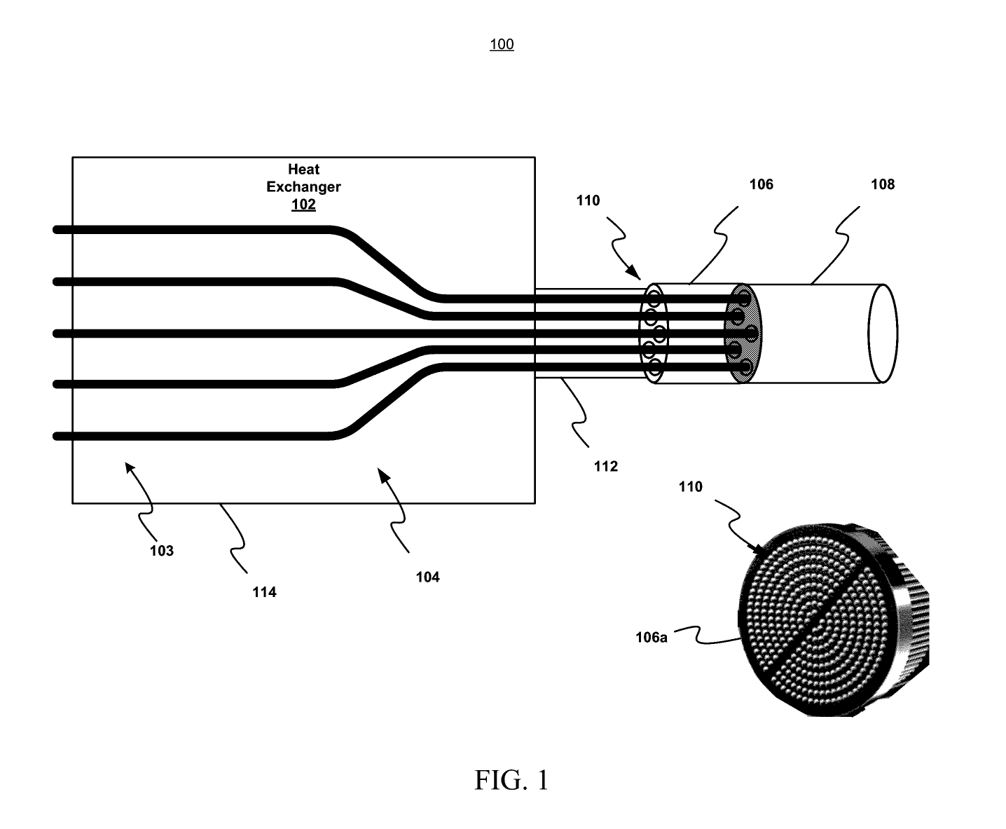

Referring now to FIG. 1, there is shown a top level system diagram 100 of a portion of a heat exchanger system. Generally a coolant is supplied to and removed from a heat exchanger apparatus 102, where the coolant may absorb or release heat as required in a particular application, using any of a variety of known techniques. FIG. 1 may serve to illustrate either the supply or removal of coolant, but for simplicity, the discussion herein will be in terms of coolant supply. It should be appreciated that reference to a coolant may also include any fluid that is relatively cooler than the fluid on the other side of the tubes.

The coolant may be supplied through a pipe 108 of a relatively large diameter, chosen to deliver coolant at a required volume and flow rate. The coolant is then channeled to a relatively large number of tubes 104. There may typically be thousands of such tubes and the tubes may be of relatively small diameter (e.g., compared to the pipe/shell). The large number of tubes may allow the coolant to be exposed to an increased surface area to improve the efficiency of thermal transfer to an opposing heat transfer fluid 103 in the heat exchanger 102. The tubes 104 may be enclosed in a protective shell casing or tube shell 112 prior to entry into the heat exchanger housing 114, where they may branch out to a desired spacing to allow the tubes to be wetted on all sides by the opposing heat transfer fluid. A header 106 may generally be configured to couple the tubes 104 to the pipe 108 so that coolant may flow from the pipe into the tubes. As illustrated, the tubes may preferably extend through the heat exchanger 102 and be recirculated as appropriate.

A more detailed picture 106a of an embodiment of the header is also shown to illustrate the relatively large number of holes 110 which may be bored or drilled through the metal plate. The tubes 104 may be run through and secured in these holes 110. The header plate may generally be fabricated from a material of relatively high strength and may be relatively thick in order to hold the tubes securely. Exemplary materials include nickel based alloys, such as an Inconel alloy. The boring of a relatively large number of holes through such material may therefore complicate the manufacturing process for the header and thus increase the cost of the heat exchange system.

The use of supercritical CO₂ heat exchange systems is becoming increasingly popular due to the potential improvements in power cycle efficiency afforded by such systems. Such systems, however, operate at increased temperatures and pressures which in turn require a greater number of tubes 104 of relatively smaller diameter. This further increases the difficulty and expense of manufacture of the header 106, due to the increased number of holes that must be bored.

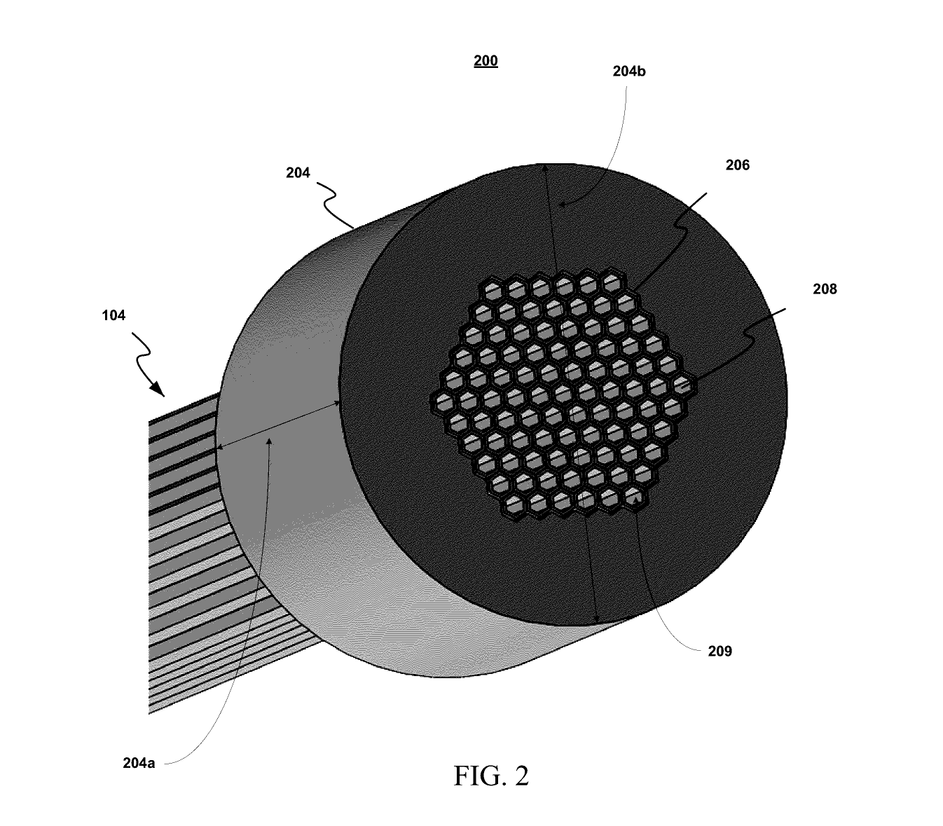

FIG. 2 illustrates a perspective view of a header configuration 200 for a heat exchanger consistent with one exemplary embodiment of the present disclosure. In this example, the individual tubes 104 have been formed into a desired geometrical configuration such as a hexagonal shape (e.g., hexagonal in cross section) and bundled together into a group where each tube is directly touching, or in close proximity, to one or more adjacent tubes.

Accordingly, a hexagonal shape may be chosen as particularly suitable, since this shape allows a tube to be in relatively close (in the event that there is some metallic binder between the tubes) or even direct contact with all surrounding adjacent tubes, although other shapes are possible as will be described. In other words, by selection of a hexagonal shape, or even a square, rectangular or even pentagonal shape, all of the relatively flat surfaces can be in direct and complete contact. However, it is also contemplated that one may utilize other polygonal shapes, containing relatively flat surfaces, where at least a portion of the relative flat surfaces may be in direct contact. That is, the tubes can be of a shape that is bounded by a finite number of flat surfaces closing to form a pathway for coolant. In addition, it is contemplated that one may utilize circular shapes, but as may be appreciated, in such a situation, there may be spaces as between the individual circular shaped tubes. In this configuration, such spaces may then be filled with a binder, such as a metallic material, to allow for thermal conductivity and prevent leakage through the header. A cross sectional view of the ends of the tubes 208, illustrating the preferred hexagonal shape more clearly, can also be seen in FIG. 2.

In connection with FIG. 2, the number of tubes 104 may fall in the range of up to 20,000 tubes and even up to 200,000 tubes or more, and the tubes may preferably have diameters in the range of 0.032″ to 0.125″ and be preferably formed of Ni based alloy. The thickness of the respective sides of the illustrated hexagonal configuration may be in the range of 0.003″ to 0.040″.

Further, in this example, an alternative design for the header 204 is shown, in which a single profiled opening (or socket) 206 is provided through which the bundle of tubes may be fitted and run. The profile of the opening 206, in this case, is substantially hexagonal to match the shape of the bundle of heat tubes. It will be appreciated that fabrication of a single relatively large profiled opening will be relatively simpler and relatively less costly than drilling many hundreds of smaller holes as in the embodiment of FIG. 1.

In addition, it should be noted that header 204 may have a thickness in the range of 1 in to 5 in as shown at 204a and a diameter as shown at 204b in the range of 1.0 inches to several feet (e.g. 1.0 inches to 10 feet) depending on the heat transfer required in the heat exchanger.

The fabrication of the configuration in FIG. 2 may be preferably achieved by fixing (e.g., brazing, soldering, welding, etc.) the individual tubes 104 to each other (e.g., adjacent tubes) to form the bundle and then inserting the bundle into the formed profiled opening 206 in the header and then fastening or fixing the bundle to the header (e.g., the end wall and/or side walls of the header). In addition, the fabrication may be achieved by preferably arranging the plurality of tubes 104 into a bundle and forming the profiled opening in the header and inserting the bundle of tubes into the profiled opening 206 and then fixing the heat exchange tubes to each other within the bundle and to the header at the same time. Reference to fixing the tubes to each other at the same time should be understood as carrying out the procedure of fixing such that, e.g., in the case of soldering, the solder will flow to fix the tubes to one another, and fix the bundle of tubes to the header, wherein the solder itself may cool and solidify at different times during the overall fixing procedure.

Soldering is reference to the process where the metal items are joined together by melting and flowing a filler metal (solder) having a lower melting point than the adjoin metals. Brazing is reference to metal joining whereby a filler metal is heated above its melting point and distributed between adjoining metal surfaces by capillary action. Welding is reference to melting of the adjoining metal surfaces and adding a filler material to form a pool of molten material that cools to form the bond.

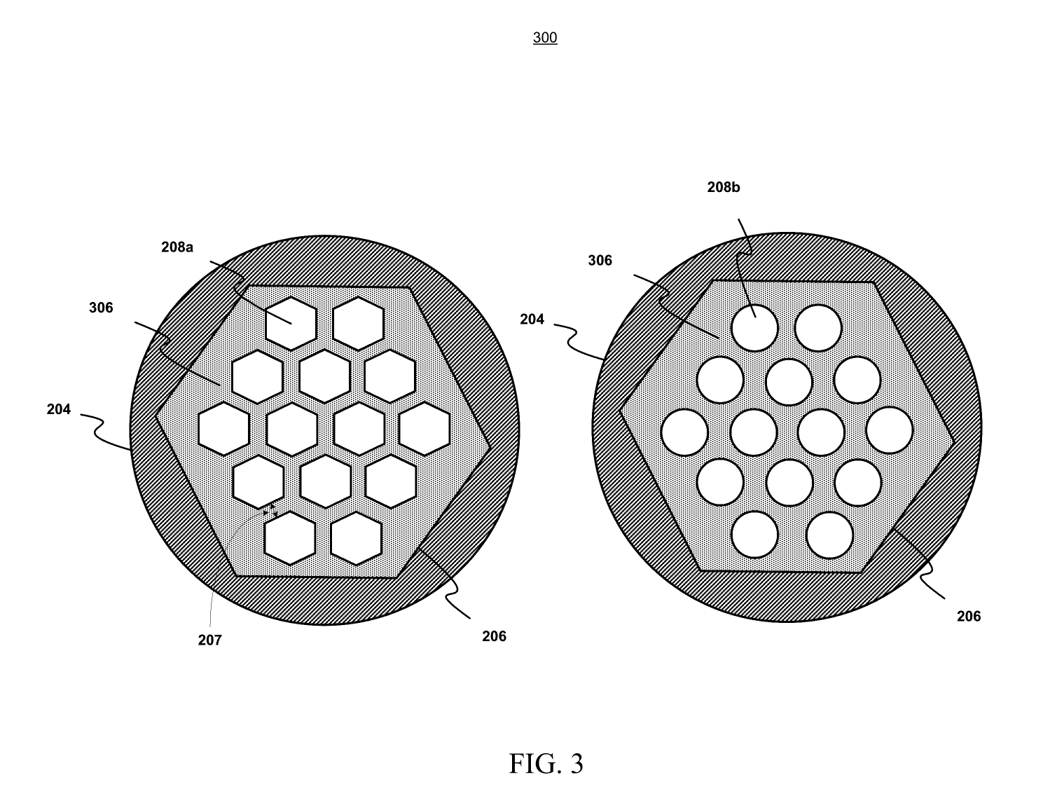

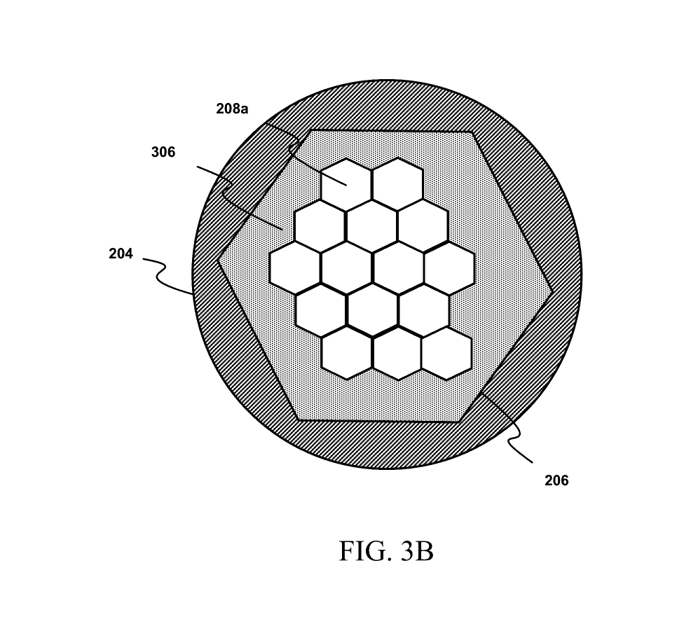

FIG. 3 illustrates cross sections 300 of header configurations in accordance with exemplary embodiments of the present disclosure. The view on the left shows hexagonal shaped tubes 208a that are embedded (e.g., fitted or run through) a hexagonal shaped profiled opening 206 interior to the header 204. The space between the tubes 208a and the profile 206 may then be filled with metallic material such as solder, brazing material, welding material or other suitable material that prevents leakage through the header. According, the space between the tubes shown at 207 may be in the range of 0.001″ to 0.015″. In addition, it can be appreciated that one need only selectively locate the solder between the tubes, so that as noted, the tubes are in direct contact with one another, such that a high percentage (90%) or more of the surface area between the tubes are in direct contact, the remaining percentage (10%) or less of the surface area between the tubes being coated with solder or any other metallic material that prevents leakage through the header.

Accordingly, the hexagonal shape tubes can be configured such that they are preferably in direct contact with one another as shown in FIG. 3B and that even more preferably, they may completely fill the hexagonal shaped profile opening 206 where all of the hexagonal shaped tubes 208a are in direct contact with one another on all of the relatively flat surfaces of the respective hexagonal tube structure and the particular hexagonal shaped tubes 209 on the outer periphery of the bundle which serve to surround the bundle are themselves in contact with the header 204. See again, FIG. 2 which identifies the header 204 and an outer peripheral hexagonal shape tube 209.

The view on the right in FIG. 3 shows an embodiment employing circular shaped tubes 208b similarly embedded (or run through) a hexagonal shaped profiled opening 206 interior to the header 204. The space between the tubes 208b and the profile 206 is again preferably filled with metallic material such as solder, brazing material, welding material or other suitable bonding material, to prevent leakage of the fluid through the header and to also provide that the bundle is fixed in place within the header. The tubes may be sized such that the solder, or other bonding material, is again capable of completely filling the gap between the tubes even when they are circular in shape. It is worth noting that the shape of the tubes 208a or 208b may be achieved through a crimping or rolling process or through the use of any other suitable fabrication technique.

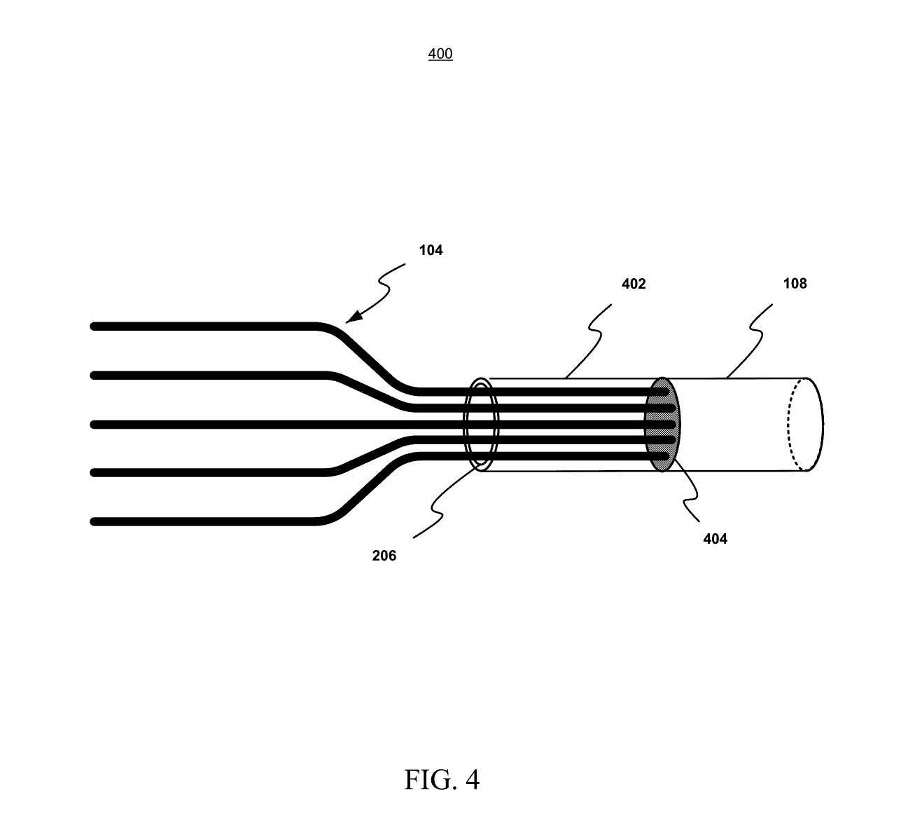

FIG. 4 illustrates a portion of a heat exchanger 400 in accordance with another exemplary embodiment of the present disclosure. The heat exchange tubes 104 are shown to converge and enter the header 402 through the profiled opening 206, which in this example is circular. The tubes 104 then run through the opening and can terminate at an end wall or end cap 404 of the header which is configured to couple or mate to the pipe 108, thus allowing the coolant to flow between the tubes and the pipe. Accordingly, it can be appreciated that by the use of tubes 104 one can pass such tubes through the profiled opening and then cause the tubes to expand to therefore further regulate the heat transfer efficiency that will occur when the tubes are in a more expanded position as shown in FIG. 4 as well as in FIG. 1. The distance between the outside surfaces of the tubes 104 prior to expansion and when the tubes are within the profiled opening may be in the range of 0 to 0.025 in and the distance between the outside surfaces of the tubes 104 after expansion and outside of the profiled opening may be in the range of 0.025 to 0.125 depending on the diameter of the tubes and the relative densities of the fluid in the tubes to the fluid surrounding the tubes.

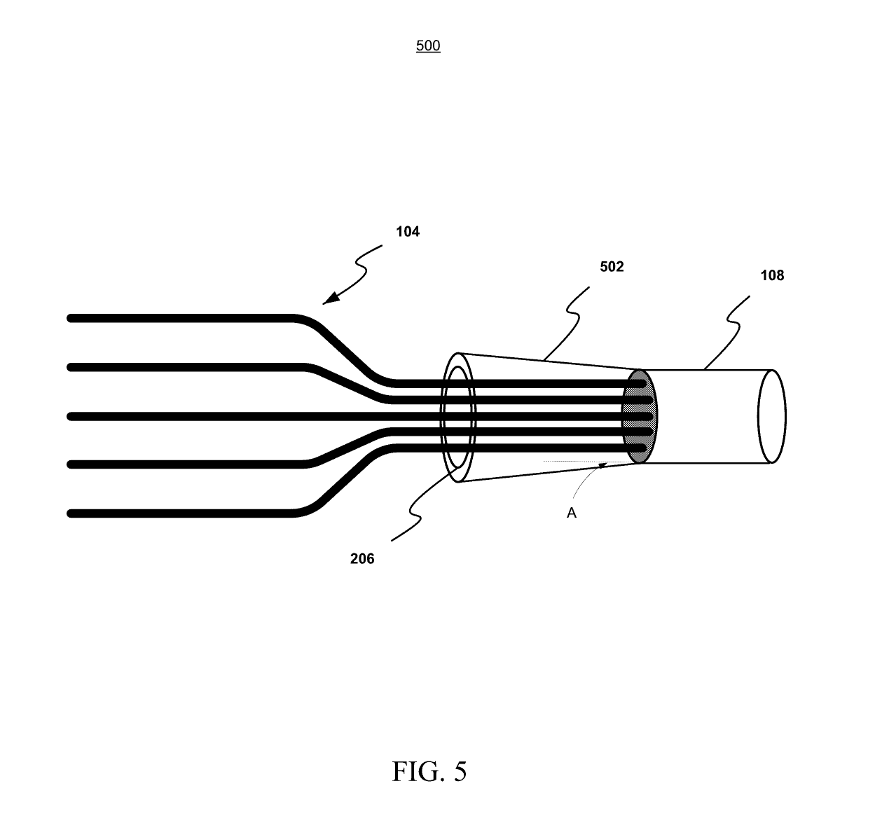

FIG. 5 illustrates a portion of a heat exchanger 500 in accordance with another exemplary embodiment of the present disclosure. The heat exchange tubes 104 are shown to converge into a bundle and enter the header 502 through the profiled opening 206. The tubes 104 run through the opening towards the pipe 108 as before. In this embodiment, however, the header 502 is shown in a tapered configuration which may facilitate the insertion and passing of the tube bundle into the header during the manufacturing/fabrication process. The taper is shown to be along an axis parallel to the bundle of tubes. The taper will preferably be in the range of 0.1-30 degrees as indicated by arrow A in FIG. 5, which defines the angle of taper relative to a horizontal extension plane of tube 108. More preferably, the taper will be in the range of 0.1-15 degrees. Additionally it is contemplated that one can manufacture a split header that is secured into place and welded in place after the tubes have been inserted similar to the closing of a vice around the tube bundle. Accordingly, header 502 may initially be in two parts which then may be clamped around tubes 104 and which may then configure the tubes into a desired shape for connection to pipe 108.

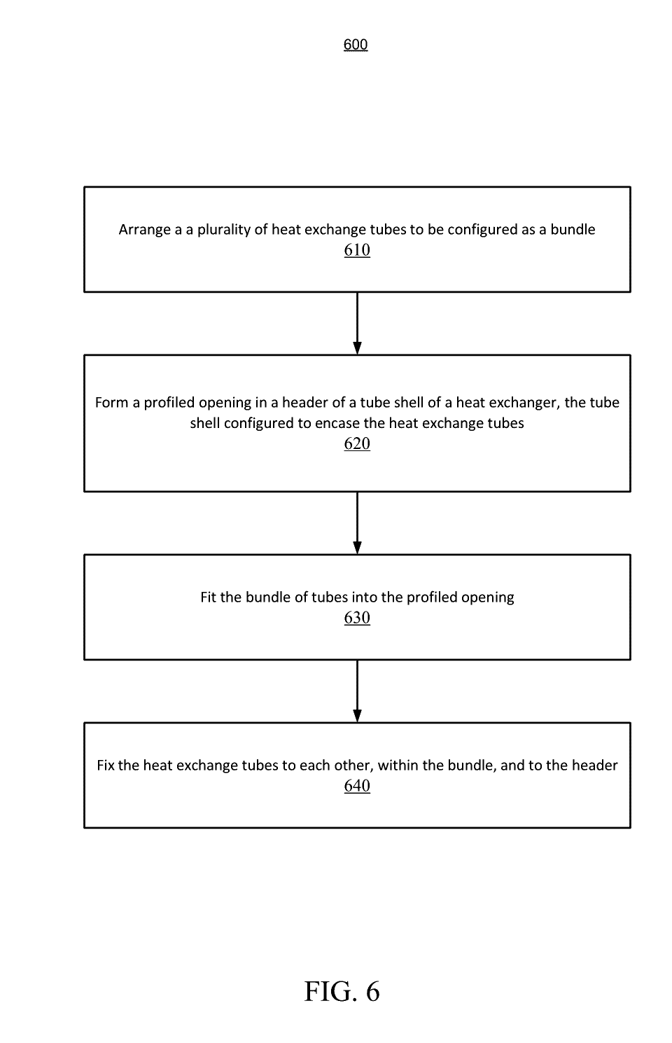

FIG. 6 illustrates a flowchart of operations 600 of another exemplary embodiment consistent with the present disclosure which describes a preferred method of manufacture. Accordingly, the operations provide a method for fabrication of the disclosed heat exchanger. At operation 610, a plurality of heat exchange tubes are arranged to be configured as a bundle (a collection of tubes). At operation 620, a profiled opening is formed in a header of a tube shell of the heat exchanger. The tube shell is configured to encase the heat exchange tubes. At operation 630, the bundle of tubes is fitted into the profiled opening. At operation 640, the heat exchange tubes are preferably fixed to each other, within the bundle, and to the header.

Thus the present disclosure provides methods and apparatus for heat exchange systems and the fabrication thereof. According to one aspect there is provided a method. The method may include arranging a plurality of heat exchange tubes to be configured as a bundle. The method may also include forming a profiled opening in a header of a tube shell of the heat exchanger. The tube shell may be configured to encase the heat exchange tubes. The method may further include fitting the bundle of tubes into the profiled opening. The method may further include fixing the heat exchange tubes to each other, within the bundle, and to the header.

According to another aspect there is provided a heat exchange apparatus. The apparatus may include a plurality of heat exchange tubes configured into a bundle.

The apparatus may also include a tube shell configured to encase a portion of the bundle. The apparatus may further include a header configured to cap and seal one end of the tube shell. The apparatus may further include a profiled opening in the header configured to allow the bundle to exit the tube shell, wherein the heat exchange tubes are fixed to each other and to the header.

The foregoing description of several methods and embodiments has been presented for purposes of illustration. It is not intended to be exhaustive or to limit the claims to the precise steps and/or forms disclosed, and obviously many modifications and variations are possible in light of the above teaching. It is intended that the scope of the invention be defined by the claims appended hereto.

What is claimed is:

1. A method for fabrication of a header for a heat exchanger, said method comprising:
arranging a plurality of heat exchange tubes to be configured as a bundle;
forming a profiled opening in a header;
fitting said bundle of tubes into said profiled opening of said header; and
fixing said heat exchange tubes to each other within said bundle and fixing said bundle to said header.

2. The method of fabrication of claim 1 wherein said fixing includes soldering, brazing or welding.

3. The method of claim 1 wherein said plurality of heat exchange tubes are of polygonal shape having a finite number of flat surfaces.

4. The method of claim 1 wherein said plurality of heat exchange tubes have a hexagonal cross-section.

5. The method of claim 3 wherein said flat surfaces of said plurality of heat exchange tubes are in direct contact with one another.

6. The method of claim 1 wherein said heat exchange tubes have a circular cross-section.

7. The method of claim 1 wherein said profiled opening is polygonal in cross-section.

8. The method of claim 1 wherein said profiled opening is hexagonal in cross-section.

9. The method of claim 1 wherein said plurality of tubes are polygonal and in direct contact with one another and wherein said plurality of tubes includes peripheral outer tubes that surround said bundle and said peripheral outer tubes are in direct contact with said header.

10. The method of claim 1, wherein said profiled opening is circular in cross section.

11. The method of claim 1, wherein said profiled opening is tapered along an axis parallel to said bundle of tubes to facilitate fitting said bundle in to said profiled opening.

12. The method of claim 1, wherein said header is positioned in a supercritical CO₂ heat exchanger.

13. A method for fabrication of a header for a heat exchanger, said method comprising:
arranging a plurality of heat exchange tubes to be configured as a bundle;
forming a profiled opening in a header;
inserting said bundle of tubes into said profiled opening; and
fixing said heat exchange tubes to each other within said bundle and to said header at the same time.

14. The method of fabrication of claim 13 wherein said fixing includes soldering, brazing or welding.

15. The method of claim 13 wherein said plurality of heat exchange tubes are of polygonal shape having a finite number of flat surfaces.

16. The method of claim 13 wherein said plurality of heat exchange tubes have a hexagonal cross-section.

17. The method of claim 15 wherein said flat surfaces of said plurality of heat exchange tubes are in direct contact with one another.

18. The method of claim 15 wherein said heat exchange tubes have a circular cross-section.

19. The method of claim 15 wherein said profiled opening is polygonal in cross-section.

20. The method of claim 15 wherein said profiled opening is hexagonal in cross-section.

21. The method of claim 15 wherein said plurality of tubes are polygonal and in direct contact with one another and wherein said plurality of tubes includes peripheral outer tubes that surround said bundle and said peripheral outer tubes are in direct contact with said header.

22. The method of claim 15, wherein said profiled opening is circular in cross section.

23. The method of claim 15, wherein said profiled opening is tapered along an axis parallel to said bundle of tubes to facilitate fitting said bundle in to said profiled opening.

24. The method of claim 15, wherein said header is positioned in a supercritical CO₂ heat exchanger.

25. A header for a heat exchanger comprising:
a plurality of heat exchange tubes configured to receive coolant;
a header containing a profiled opening to receive said plurality of heat exchange tubes wherein said header is configured to be sealingly engaged to a pipe for delivery of coolant between said pipe and said plurality of heat exchange tubes.

26. The header of claim 25, wherein said heat exchange tubes are fixed by soldering, brazing or welding.

27. The header of claim 25, wherein said heat exchange tubes are configured to have a polygonal cross section.

28. The header of claim 25, wherein said heat exchange tubes are configured to have a circular cross section.

29. The header of claim 25, wherein said profiled opening is hexagonal in cross section.

30. The header of claim 25, wherein said profiled opening is circular in cross section.

31. The header of claim 25, wherein said heat exchanger is a supercritical CO₂ heat exchanger.
